(19) United States
(12) Patent Application Publication
(10) Pub. No.: US 2013/0265083 A1
(43) Pub. Date: Oct. 10, 2013

(54) VOLTAGE AND CURRENT REFERENCE GENERATOR

(71) Applicant: NOVATEK MIRCOELECTRONICS CORP., Hsinchu (TW)

(72) Inventors: Yung-Chou LIN, Hsinchu City (TW); Tsung-Hau CHANG, Hsinchu City (TW)

(73) Assignee: Novatek Microelectronics Corp., Hsinchu (TW)

(21) Appl. No.: 13/715,368

(22) Filed: Dec. 14, 2012

(30) Foreign Application Priority Data
Apr. 5, 2012 (TW) 101112111

(51) Int. Cl. H02M 11/00

(52) U.S. Cl. CPC H02M 11/00
USPC 327/103

(57) ABSTRACT

A voltage and current reference generator includes: a temperature-insensitive voltage source for providing a first current with a positive temperature coefficient and a reference voltage with a substantially zero temperature coefficient according to a junction voltage difference with a negative temperature coefficient; a mirror unit for mirroring the first current to obtain a second current with the positive temperature coefficient and for generating a junction voltage with the negative temperature coefficient according to the second current; a voltage-to-current conversion unit for converting the junction voltage into a third current with the negative temperature coefficient; and a current integration unit for obtaining a fourth current and a fifth current, and integrating the fourth current and the fifth current into a reference current having a substantially zero temperature coefficient.

This application claims the benefit of Taiwan application Serial No. 101112111, filed Apr. 5, 2012, the subject matter of which is incorporated herein by reference.

### BACKGROUND OF THE DISCLOSURE

1. Field of the Disclosure

The disclosure relates in general to a voltage and current reference generator, and more particularly to a voltage and current reference generator and a voltage and current reference generating method for providing a reference current and a reference voltage which are insensitive or irrelevant to temperature or temperature variation.

2. Description of the Related Art

Nowadays, as the rapid development of scientific technology makes popular power supply circuits which are insensitive or irrelevant to temperature or temperature variation. These power supply circuits supply power to several load circuits which are sensitive to temperature. In general, current temperature-insensitive power supply circuits use several subunits with different temperature characteristics, such as a subunit for providing an electric signal with a positive temperature coefficient and a subunit for providing an electric signal with a negative temperature coefficient. Then, the electric signal with the positive temperature coefficient and the electric signal with the negative temperature coefficient are integrated into a reference electric signal which is regarded as substantially insensitive to temperature variation. However, it is a subject of the industrial endeavors to design a temperature-insensitive power supply circuit which is more convenient and desirable to provide temperature-sensitive load circuits with temperature-insensitive electric signals.

### SUMMARY OF THE DISCLOSURE

The disclosure is directed to a voltage and current reference generator which has high noise immunity. In the voltage and current reference generator, there is a temperature-insensitive voltage source which may use an N-channel metal-oxide-semiconductor (MOS) transistor operated in the saturation region as a voltage biased transistor. Such a transistor can provide a bias current less sensitive to the variation of the supply voltage, so that the voltage and current reference generator can generate a reference voltage with high power noise immunity. The disclosure also provides a voltage and current reference generating method.

According to an aspect of the present disclosure, a voltage and current reference generator is provided. The voltage and current reference generator includes a temperature-insensitive voltage source, a mirror unit, a voltage-to-current conversion unit, and a current integration unit. The temperature-insensitive voltage source is for providing a first current with a positive temperature coefficient and a reference voltage with a substantially zero temperature coefficient according to a junction voltage difference with a negative temperature coefficient. The mirror unit is coupled to the temperature-insensitive voltage source. The mirror unit mirrors the first current to obtain a second current with the positive temperature coefficient. The mirror unit further generates a junction voltage with the negative temperature coefficient according to the second current. The voltage-to-current conversion unit is coupled to the mirror unit. The voltage-to-current conversion unit converts the junction voltage into a third current with the negative temperature coefficient. The current integration unit is coupled to the mirror unit for mirroring the second current to obtain a fourth current. The current integration unit is coupled to the voltage-to-current conversion unit for mirroring the third current to obtain a fifth current. The current integration unit integrates the fourth current and the fifth current into a reference current having a substantially zero temperature coefficient.

According to another aspect of the present disclosure, a voltage and current reference generator is provided, comprising: a temperature-insensitive voltage source, comprising: an operational amplifier having a first input terminal, a second input terminal, and an output terminal; a first bias metal-oxide-semiconductor transistor having a first gate coupled to the output terminal of the operational amplifier; a bandgap reference circuit, comprising: a plurality of first junction transistors, and a plurality of resistors coupled to the first and second input terminals of the operational amplifier and the first bias metal-oxide-semiconductor transistor; a mirror unit coupled to the temperature-insensitive voltage source, comprising: a mirror metal-oxide-semiconductor transistor having a gate coupled to the gate of the first bias metal-oxide-semiconductor transistor; and a second junction transistor coupled to a source/drain of the mirror metal-oxide-semiconductor transistor; a voltage-to-current conversion unit coupled to the mirror unit, comprising: an operational amplifier having a first input terminal coupled to the mirror unit, a second input terminal, and an output terminal; a resistor coupled between the second input terminal and a voltage source; and a second bias metal-oxide-semiconductor transistor having a gate coupled to the output terminal of the operational amplifier, a first source/drain coupled to the second input terminal of the operational amplifier, and a second source/drain; and a current integration unit coupled to the mirror unit and the voltage-to-current conversion unit, comprising: a first current mirror unit coupled between a source/drain of the mirror metal-oxide-semiconductor transistor of the mirror unit and an integration node; and a second current mirror unit coupled between the second source/drain of the voltage-to-current conversion unit and the integration node.

According to further another aspect of the present disclosure, a voltage and current reference generating method is provided, comprising: providing a first current with a positive temperature coefficient and a reference voltage with a substantially zero temperature coefficient according to a junction voltage difference with a negative temperature coefficient; mirroring the first current to obtain a second current with the positive temperature coefficient, the mirror unit further generating a junction voltage with the negative temperature coefficient according to the second current; converting the junction voltage into a third current with the negative temperature coefficient; and mirroring the second current to obtain a fourth current, and mirroring the third current to obtain a fifth current, and integrating the fourth current and the fifth current into a reference current having a substantially zero temperature coefficient.

The above and other aspects of the disclosure will become better understood with regard to the following detailed description of the preferred but non-limiting embodiment(s). The following description is made with reference to the accompanying drawings.

### BRIEF DESCRIPTION OF THE DRAWINGS

FIG. 1 is a circuit diagram showing a voltage and current reference generator according to an embodiment of the disclosure

FIG. 2 is a circuit diagram showing a voltage and current reference generator according to another embodiment of the disclosure.

FIG. 3 is a circuit diagram showing a voltage and current reference generator according to another embodiment of the disclosure.

### DETAILED DESCRIPTION OF THE DISCLOSURE

The disclosure provides exemplary embodiments of a voltage and current reference generator which has high noise immunity. In some embodiments of the voltage and current reference generator, there is a temperature-insensitive voltage source which may use an N-channel metal-oxide-semiconductor (MOS) transistor operated in the saturation region as a voltage biased transistor. Such a transistor can provide a bias current less sensitive to the variation of the supply voltage, so that the voltage and current reference generator can generate a reference voltage with high power noise immunity. The disclosure will become better understood with regard to the following detailed description of the exemplary embodiments made with reference to the accompanying drawings. Besides, as to terms mentioned in the embodiments such as “coupled” or “connected”, they can be realized as one made with reference to the accompanying drawings merely for the sake of illustration, rather than being limited to a direct connection or an indirect connection between two elements in different implementations.

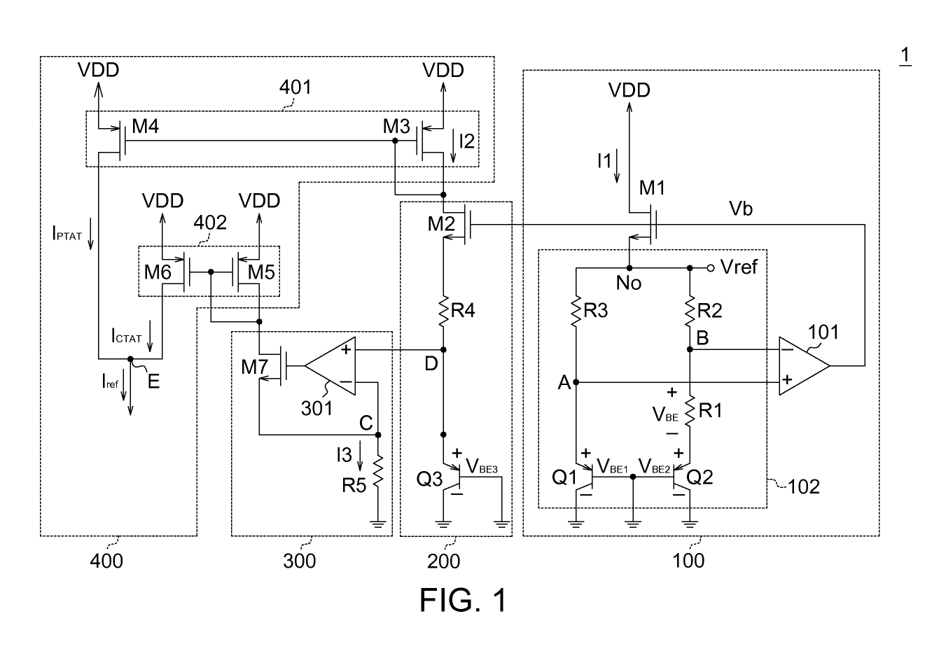

FIG. 1 is a circuit diagram showing a voltage and current reference generator according to an embodiment of the disclosure. In the embodiment, a voltage and current reference generator 1 includes a temperature-insensitive voltage source 100, a mirror unit 200, a voltage-to-current conversion unit 300, and a current integration unit 400. The temperature-insensitive voltage source 100 is coupled to the mirror unit 200. The mirror unit 200 is coupled to the voltage-to-current conversion unit 300 and the current integration unit 400. The voltage-to-current conversion unit 300 is coupled to the current integration unit 400.

The temperature-insensitive voltage source 100 provides a first current I1 with a positive temperature coefficient P and a reference voltage Vref with a substantially zero temperature coefficient according to a junction voltage difference V_{BE} with a negative temperature coefficient N. For example, the temperature-insensitive voltage source 100 can include an operational amplifier 101, a bias metal-oxide-semiconductor transistor M1, and a bandgap reference circuit 102. The bandgap reference circuit 102 includes a node A, a node B, a node No, resistors R1-R3, and junction transistors Q1 and Q2. The resistor R2 is coupled between the nodes B and No, while the resistor R3 is coupled between the nodes A and No. The junction transistors Q1 and Q2 are for example implemented by PNP-type bipolar junction transistor (BJT). The junction transistor Q1 has an emitter coupled to the node A, while the junction transistor Q2 has an emitter coupled to the node B via the resistor R1. The junction transistors Q1 and Q2 each have a base and a collector for receiving a ground voltage GND.

The operational amplifier 101 has a positive input terminal, a negative input terminal, and an output terminal. The positive input terminal and the negative input terminal are coupled to the nodes A and B, respectively. The bias metal-oxide-semiconductor transistor M1 has a gate coupled to the output terminal of the operational amplifier 101, so as to generate a current I1 in response to a voltage Vb at the output terminal of the operational amplifier 101.

In some embodiments, the bias metal-oxide-semiconductor transistor M1 is preferably implemented by an N-channel metal-oxide-semiconductor transistor, having a drain for receiving a supply voltage VDD and a source coupled to the node No. As such, when the supply voltage VDD becomes unstable due to noise interference or other undesirable conditions, the variation or fluctuation of the supply voltage VDD causes the bias metal-oxide-semiconductor transistor M1 to have a voltage change at its drain correspondingly. However, as to voltages at the gate and source of the bias metal-oxide-semiconductor transistor M1, they are less affected by the variation or fluctuation of the supply voltage VDD. In addiction, when being operated in the saturation region, a metal-oxide-semiconductor transistor has a drain current mainly related to the gate-source voltage thereof and substantially irreverent or insensitive to the drain voltage thereof. Thus, the temperature-insensitive voltage source 100 using an N-channel metal-oxide-semiconductor transistor as the bias metal-oxide-semiconductor transistor M1 has high noise immunity to the supply voltage VDD. In this way, the temperature-insensitive voltage source 100 can provide the current I1 stably and effectively even the supply voltage VDD is unstable.

The bandgap reference circuit 102 is coupled to the positive input terminal of the operational amplifier 101 via the node A, to the negative input terminal of the operational amplifier 101 via the node B, and to the source of the bias metal-oxide-semiconductor transistor M1 via the node No. The bandgap reference circuit 10 generates the junction voltage difference V_{BE}, and obtains the reference voltage Vref according to the first current I1 and the junction voltage difference V_{BE}.

For further illustration, the junction voltage difference V_{BE} is for example a difference between a base-source voltage V_{BE1} of the junction transistor Q1 and a base-source voltage V_{BE2} of the junction transistor Q2, which can be expressed by an equation as follows:

$${V}_{BE} = {V}_{BE 1} - {V}_{BE 2} = \frac{KT}{q } ln ( \frac{{I}_{Q 1}}{{I}_{S 1}} ) - \frac{KT}{q} ln ( \frac{{I}_{Q 2}}{{I}_{S 2}} ) ,$$

where K, T, and q are for example a Boltzmann Constant, an absolute temperature, and a unit constant of electrical charge, respectively; I_{S1} and I_{S2} are saturation currents of the junction transistors Q1 and Q2; I_{Q1} and I_{Q2} are emitter currents flowing through the junction transistors Q1 and Q2.

It is assumed that the saturation currents I_{S2} and I_{S1} of the junction transistors Q2 and Q1 have a ratio of M:1, while the emitter currents I_{Q1} and I_{Q2} are substantially the same. Then, derived from the aforementioned equation, equations of the emitter currents I_{Q1}, I_{Q2} and the reference voltage Vref can be expressed as follows:

$${V}_{BE} = \frac{KT}{q} ln ( M \times \frac{{I}_{Q 1}}{{I}_{Q 2}} ) = \frac{KT}{q} ln ( M ) , \\ {I}_{Q 2} = \frac{{V}_{BE}}{R 2} = \frac{KT}{R 2 \times q} ln ( M ) = {I}_{Q 1} , \\ Vref = {V}_{BE 1} + R 3 \times {I}_{Q 1} = {V}_{BE 1} + \frac{R 3}{R 2} \frac{KT}{q} ln ( M ) ,$$

where M is a positive real number. As to the equation of the reference voltage Vref, its first term and second term at the right side are corresponding to the negative temperature coefficient N and positive temperature coefficient P, respectively. As such, by adjusting the ratio between the first term and the second term in the equation of the reference voltage Vref, the corresponding negative temperature coefficient N and the positive temperature coefficient P can be compensated for each other, so that the reference voltage Vref can have a substantially zero temperature coefficient.

The mirror unit 200 mirrors the first current I1 to obtain a second current I2 with the positive temperature coefficient P. The mirror unit 200 further generates a junction voltage V_{BE3} with the negative temperature coefficient N according to the second current I2. The mirror unit 200 includes a mirror metal-oxide-semiconductor transistor M2, a resistor R4, a node D, and a junction transistor Q3. The mirror metal-oxide-semiconductor transistor M2 has a source coupled to a terminal of the resistor R4, and the other terminal of the resistor R4 is coupled to the node D. The junction transistor Q3 is coupled to the node D.

The mirror metal-oxide-semiconductor transistor M2 has a gate coupled to the gate of the bias metal-oxide-semiconductor transistor M1. Thus, when the metal-oxide-semiconductor transistor M2 and the bias metal-oxide-semiconductor transistor M1 both receive a voltage Vb output from the output terminal of the operational amplifier 101, the current I1 is mirrored and the current I2 is obtained. When the current I2 is determined, the junction voltage V_{BE3} of the junction transistor Q3 also is determined. In other words, the junction transistor Q3 generates the junction voltage V_{BE3} according to the current I2. In some embodiments, the mirror unit 200 can be implemented by making the mirror metal-oxide-semiconductor transistor M2, the resistor R4, and the junction transistor Q3 be realized in correspondence to the bias metal-oxide-semiconductor transistor M1, the resistor R3, and the junction transistor Q1 in the temperature-insensitive voltage source 100. For example, the corresponding elements can realized as having corresponding structures and substantially same characteristic. In other words, the bias metal-oxide-semiconductor transistor M1 and the mirror metal-oxide-semiconductor transistor M2 are substantially same circuit elements, so are resistors R4 and R3, junction transistors Q3 and Q1. In this way, when a voltage such as the voltage Vb is applied to both the bias metal-oxide-semiconductor transistor M1 and the mirror metal-oxide-semiconductor transistor M2, the mirror unit 200 can obtain the current I2 with positive temperature coefficient P (substantially equal to the current I1), and the junction voltage V_{BE3} with negative temperature coefficient N (substantially equal to the junction voltage V_{BE1}). In other words, the mirror unit 200 not only obtains a copy of the current I1, but one of the junction voltage V_{BE1}.

The voltage-to-current conversion unit 300 converts the junction voltage V_{BE3} into a third current I3 with a negative temperature coefficient N. For example, the voltage-to-current conversion unit 300 includes an operational amplifier 301, a resistor R5, a node C, and a bias metal-oxide-semiconductor transistor M7. The operational amplifier 301 has a positive input terminal coupled to the node D of the mirror unit 200, a negative input terminal coupled to the node D of the mirror unit 200, and an output terminal coupled to a gate of the bias metal-oxide-semiconductor transistor M7. The bias metal-oxide-semiconductor transistor M7 has a source coupled to the node C. The resistor R5 has a terminal coupled to the node C and another terminal for receiving the ground voltage GND.

The voltage-to-current conversion unit 300 visualizes a virtual short between the nodes C and D, so that the node C has a voltage substantially equal to the junction voltage V_{BE3}. As such, the resistor R5 is for generating the current I3 with the negative temperature coefficient N in response to the junction voltage V_{BE3} applied to the two terminals of the resistor R5.

The current integration unit 400 mirrors the second current I2 to obtain a current I_{PTAT}. The current integration unit 400 further mirrors the third current I3 to obtain a current I_{CTAT}. The current integration unit 400 integrates the currents I_{PTAT} and I_{CTAT} into a reference current Iref having a substantially zero temperature coefficient. The current integration unit 400 includes a current mirror unit 401, a current mirror unit 402, and an integration node E. The current mirror unit 401 is coupled between the mirror unit 200 and the integration node E, so as to mirror the current I2 to obtain the current I_{PTAT}. For example, the current mirror unit 401 includes transistors M4 and M3 having sources for receiving the supply voltage VDD, gates coupled to each other, and drains coupled to the integration node E and the drain of the mirror metal-oxide-semiconductor transistor M2, respectively.

The current mirror unit 402 is coupled between the voltage-to-current conversion unit 300 and the integration node E, so as to mirror the current I3 to obtain the current I_{CTAT}. For example, the current mirror unit 402 includes transistors M6 and M5 having sources or receiving the supply voltage VDD, gates coupled to each other, and drains coupled to the integration node E and the drain of the bias metal-oxide-semiconductor transistor M7, respectively.

According to the aforementioned description of the disclosure, the voltage and current reference generator 1 can provide a reference Iref with a substantially zero temperature coefficient and a reference voltage Vref with a substantially zero temperature coefficient.

In the disclosed embodiments of the disclosure, the voltage and current reference generator 1 is exemplified as having the circuit diagram shown in FIG. 1, but the disclosure is not limited thereto. In other embodiments, the operational amplifier 301 of the voltage-to-current conversion unit 300 can have a positive input terminal coupled to the node A of the temperature-insensitive voltage source 100. In this way, the node C is biased at the junction voltage V_{BE1} due to the visual short circuit.

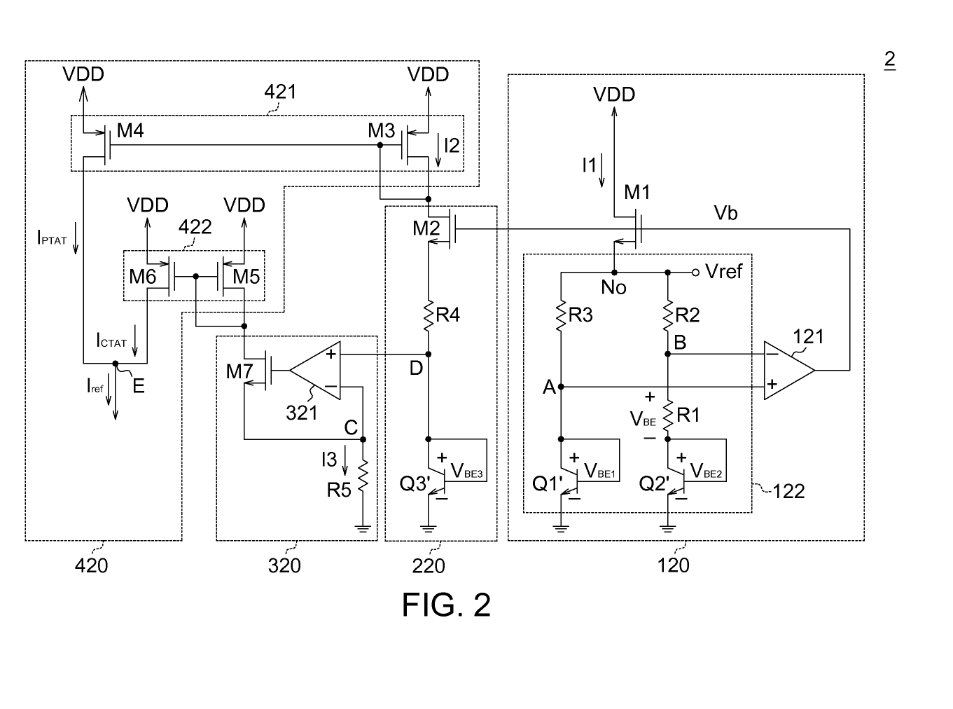

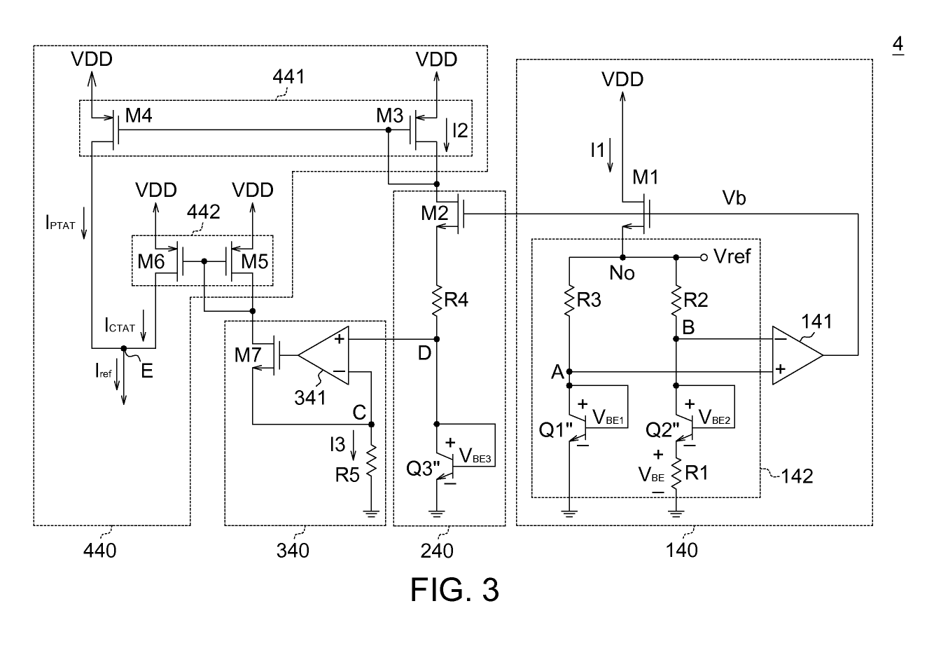

FIG. 2 is a circuit diagram showing a voltage and current reference generator according to another embodiment of the disclosure. In this embodiment, a temperature-insensitive voltage source 120 and a mirror unit 220 can have junction transistors Q1′ and Q3′ implemented by NPN-type bipolar junction transistors (BJT), as shown in FIG. 2. FIG. 3 is a circuit diagram showing a voltage and current reference generator according to another embodiment of the disclosure. In this embodiment, a temperature-insensitive voltage source 140 and a mirror unit 240 can have junction transistors Q1″ and Q3″ whose coupling relationship is shown in FIG. 3.

According to the disclosed embodiments of the voltage and current reference generator, a temperature-insensitive voltage source is used to provide a first current with a positive temperature coefficient, a junction voltage difference with a negative temperature coefficient, and a reference voltage with a substantially zero temperature coefficient. According to the embodiments of the voltage and current reference generator, a mirror unit is used to mirror the first current to obtain a second current with the positive temperature coefficient, and a junction voltage with the negative temperature coefficient. Moreover, a voltage-to-current conversion unit is used to obtain a third current with the negative temperature coefficient according to the junction voltage. According to the embodiments of the voltage and current reference generator, a current integration unit is used to mirror the second current and the third current to obtain a fourth current with the positive temperature coefficient and a fifth current with the negative temperature coefficient, respectively. The current integration unit then integrates the fourth current and the fifth current into a reference current having a substantially zero temperature coefficient. Thus, as compared with a conventional voltage reference generator or current reference generator, the embodiments of the voltage and current reference generator is advantageous to provide a reference current with a substantially zero temperature coefficient and a reference voltage with a substantially zero temperature coefficient.

Besides, as to the embodiments of the voltage and current reference generator, an N-channel MOS transistor having a drain for receiving the supply voltage VDD may be used as a voltage biased transistor. As such, when the supply voltage VDD becomes unstable due to noise interference or other undesirable conditions, the variation or fluctuation of the supply voltage VDD causes the bias metal-oxide-semiconductor transistor M1 to have a voltage change at its drain correspondingly. However, as to voltages at the gate and source of the bias metal-oxide-semiconductor transistor M1, they are less affected by the variation or fluctuation of the supply voltage VDD. Thus, as compared with a conventional voltage reference generator or current reference generator, the voltage and current reference generator may have higher noise immunity.

While the disclosure has been described by way of example and in terms of the preferred embodiment(s), it is to be understood that the disclosure is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A voltage and current reference generator, comprising
a temperature-insensitive voltage source for providing a first current with a positive temperature coefficient and a reference voltage with a substantially zero temperature coefficient according to a junction voltage difference with a negative temperature coefficient;
a mirror unit coupled to the temperature-insensitive voltage source, the mirror unit mirroring the first current to obtain a second current with the positive temperature coefficient, the mirror unit further generating a junction voltage with the negative temperature coefficient according to the second current;
a voltage-to-current conversion unit coupled to the mirror unit, the voltage-to-current conversion unit converting the junction voltage into a third current with the negative temperature coefficient; and
a current integration unit coupled to the mirror unit for mirroring the second current to obtain a fourth current, the current integration unit coupled to the voltage-to-current conversion unit for mirroring the third current to obtain a fifth current, the current integration unit integrating the fourth current and the fifth current into a reference current having a substantially zero temperature coefficient.

2. The voltage and current reference generator according to claim 1, wherein the temperature-insensitive voltage source comprises:
an operational amplifier having a first input terminal, a second input terminal, and an output terminal;
a first bias metal-oxide-semiconductor transistor having a first gate coupled to the output terminal of the operational amplifier, so as to provide the first current in response to a voltage level at the output terminal of the operational amplifier; and
a bandgap reference circuit coupled to the first input terminal of the operational amplifier, the second input terminal of the operational amplifier, and a source/drain of the first bias metal-oxide-semiconductor transistor, the bandgap reference circuit being for generating the junction voltage difference, the bandgap reference circuit obtaining the reference voltage according to the first current and the junction voltage difference.

3. The voltage and current reference generator according to claim 2, wherein the bandgap reference circuit comprises:
a plurality of junction transistors for providing a plurality of base-emitter voltage difference, so as to generate the junction voltage difference;
a plurality of resistors coupled to the first input terminal of the operational amplifier, the second input terminal of the operational amplifier, the first bias metal-oxide-semiconductor transistor, and the junction transistors, so as to obtain the reference voltage according to the first current and the junction voltage difference.

4. The voltage and current reference generator according to claim 2, wherein the first bias metal-oxide-semiconductor transistor is an N-channel metal-oxide-semiconductor transistor.

5. The voltage and current reference generator according to claim 2, wherein the mirror unit comprises:
a mirror metal-oxide-semiconductor transistor having a gate coupled to the gate of the first bias metal-oxide-semiconductor transistor, so as to receive a bias at the gate of the first bias metal-oxide-semiconductor transistor, and mirror the first current to obtain the second current; and
a junction transistor coupled to a source/drain of the mirror metal-oxide-semiconductor transistor, so as to generate the junction voltage according to the second current.

6. The voltage and current reference generator according to claim 5, wherein the first bias metal-oxide-semiconductor transistor and the mirror metal-oxide-semiconductor transistor are N-channel metal-oxide-semiconductor transistors.

7. The voltage and current reference generator according to claim 1, wherein the mirror unit comprises:
a mirror metal-oxide-semiconductor transistor having a gate coupled to the temperature-insensitive voltage source, so as to receive a bias from the temperature-insensitive voltage source, and mirror the first current to obtain the second current; and
a junction transistor coupled to the mirror metal-oxide-semiconductor transistor, so as to generate the junction voltage according to the second current.

8. The voltage and current reference generator according to claim 1, wherein the voltage-to-current conversion unit comprises:
an operational amplifier having a first input terminal, a second input terminal, and an output terminal, the first input terminal of the operational amplifier being for receiving the junction voltage of the mirror unit;
a resistor coupled between the second input terminal and a voltage source; and
a second bias metal-oxide-semiconductor transistor having a gate coupled to the output terminal of the operational amplifier, a first source/drain coupled to the second input terminal of the operational amplifier, and a second source/drain coupled to the current integration unit.

9. The voltage and current reference generator according to claim 1, wherein the current integration unit comprises:
a first current mirror unit coupled between the mirror unit and an integration node, so as to mirror the second current to obtain the fourth current; and
a second current mirror unit coupled between the voltage-to-current conversion unit and the integration node, so as to mirror the third current to obtain the fifth current;
wherein the fourth current and the fifth current are integrated into the reference current at the integration node.

10. A voltage and current reference generator, comprising
a temperature-insensitive voltage source, comprising:
an operational amplifier having a first input terminal, a second input terminal, and an output terminal;
a first bias metal-oxide-semiconductor transistor having a first gate coupled to the output terminal of the operational amplifier;
a bandgap reference circuit, comprising: a plurality of first junction transistors, and a plurality of resistors coupled to the first and second input terminals of the operational amplifier and the first bias metal-oxide-semiconductor transistor;
a mirror unit coupled to the temperature-insensitive voltage source, comprising:
a mirror metal-oxide-semiconductor transistor having a gate coupled to the gate of the first bias metal-oxide-semiconductor transistor; and
a second junction transistor coupled to a source/drain of the mirror metal-oxide-semiconductor transistor;
a voltage-to-current conversion unit coupled to the mirror unit, comprising:
an operational amplifier having a first input terminal coupled to the mirror unit, a second input terminal, and an output terminal;
a resistor coupled between the second input terminal and a voltage source; and
a second bias metal-oxide-semiconductor transistor having a gate coupled to the output terminal of the operational amplifier, a first source/drain coupled to the second input terminal of the operational amplifier, and a second source/drain; and
a current integration unit coupled to the mirror unit and the voltage-to-current conversion unit, comprising:
a first current mirror unit coupled between a source/drain of the mirror metal-oxide-semiconductor transistor of the mirror unit and an integration node; and
a second current mirror unit coupled between the second source/drain of the voltage-to-current conversion unit and the integration node.

11. The voltage and current reference generator according to claim 10, wherein the first bias metal-oxide-semiconductor transistor and the mirror metal-oxide-semiconductor transistor are N-channel metal-oxide-semiconductor transistors.

12. The voltage and current reference generator according to claim 10, wherein the first junction transistors and the second junction transistor are implemented by NPN-type bipolar junction transistors (BJT).

13. The voltage and current reference generator according to claim 10, wherein the first junction transistors and the second junction transistor are implemented by PNP-type bipolar junction transistors (BJT).

14. A voltage and current reference generating method, comprising
providing a first current with a positive temperature coefficient and a reference voltage with a substantially zero temperature coefficient according to a junction voltage difference with a negative temperature coefficient;
mirroring the first current to obtain a second current with the positive temperature coefficient, the mirror unit further generating a junction voltage with the negative temperature coefficient according to the second current;
converting the junction voltage into a third current with the negative temperature coefficient; and
mirroring the second current to obtain a fourth current, and mirroring the third current to obtain a fifth current, and integrating the fourth current and the fifth current into a reference current having a substantially zero temperature coefficient.
